(19) United States
(12) Patent Application Publication
(10) Pub. No.: US 2008/0147605 A1
(43) Pub. Date: Jun. 19, 2008

(54) APPARATUS AND METHOD FOR CREATING A CUSTOMIZED VIRTUAL DATA SOURCE

(75) Inventors: Dinial BENSALAH, Courbevoie (FR); Florin Alexandru DRAGAN, Versaille (FR); Francois LLIRBAT, Bagnolet (FR); Olivier Philippe PIERRET, Paris (FR); Eric SIMON, Juvisy (FR)

Correspondence Address: COOLEY GODWARD KRONISH LLP;ATTN: Patent Group, Suite 1100, 777 - 6th Street, NW, Washington, DC, 20001, US

(73) Assignee: BUSINESS OBJECTS, S.A., Levallois-Perret (FR)

(21) Appl. No.: 11/611,807

(22) Filed: Dec. 15, 2006

(51) Int. Cl. G06F 17/30

(52) U.S. Cl. 707/3; 707/102; 707/E17.045; 707/E17.014

(57) ABSTRACT

The invention includes a computer readable storage medium with executable instructions to translate a data source into a set of data elements, where a data element in the set of data elements includes a set of data properties. The set of data elements is displayed using a visualization. A group of data elements selected from the set of data elements is received. A group of data properties selected from the set of data properties associated with each data element in the group of data elements is received. A table schema for data elements in the group of data elements is provided. The group of data elements is converted into a target data source.

### BRIEF DESCRIPTION OF THE INVENTION

This invention relates generally to the processing of digital data. More particularly, this invention relates to techniques for creating a customized virtual data source.

### BACKGROUND OF THE INVENTION

Creating a customized virtual data source, especially from a text file or Extensible Markup Language (XML) file, is problematic. Prior art techniques require the user to select an entire data element from the data source when only a subset of the data properties of a data element are needed. Relationships between data elements are not provided, requiring the user to be familiar with these relationships in order to select the correct set of data elements. Furthermore, when the data source is a text file or XML file, the user must be familiar with the structure of the file to specify how the file should be parsed.

In view of the foregoing, it would be highly desirable to develop an application that automatically extracts the data elements of a data source, provides the data element relationships and gives the user more flexibility in customizing the virtual data source.

### SUMMARY OF INVENTION

The invention includes a computer readable storage medium with executable instructions to translate a data source into a set of data elements, where a data element in the set of data elements includes a set of data properties. The set of data elements is displayed using a visualization. A group of data elements selected from the set of data elements is received. A group of data properties selected from the set of data properties associated with each data element in the group of data elements is received. A table schema for data elements in the group of data elements is provided. The group of data elements is converted into a target data source.

The invention also includes a computer enabled method for specifying aspects of a target virtual data source. The method includes receiving a data source with a set of data elements and receiving a group of data elements from the set of data elements via a visualization, where a data element in the set of data elements comprises a set of data properties. A subset of data properties from the set of data properties is received for each data element in the group of data elements via the visualization. A table schema is provided for data elements in the group of data elements. The group of data elements is converted into a target data source.

The invention also includes a computer readable storage medium with executable instructions to receive an XML file, display the XML file using a visualization, where the XML file expresses a set of concepts, and receive a group of concepts selected from the set of concepts, where a concept in the set of concepts includes a set of attributes. A group of attributes selected from the set of attributes is received for each data element in the group of data elements. A table schema is specified for each concept in the group of concepts. The group of concepts is converted into a virtual relational database.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates processing operations associated with an embodiment of the invention.

FIG. 3 illustrates a Graphical User Interface displaying the data elements extracted from a data source using a list visualization configured in accordance with an embodiment of the invention.

FIG. 4 illustrates the data elements extracted from a data source using a tree visualization configured in accordance with an embodiment of the invention.

FIG. 5 illustrates the detail display of a data element in the tree of FIG. 4 in accordance with an embodiment of the invention.

FIG. 6 illustrates only the selected data elements of the tree of FIG. 4 in accordance with an embodiment of the invention.

FIG. 7 illustrates only the selected data elements and their immediate children of the tree hierarchy of FIG. 4 in accordance with an embodiment of the invention

FIG. 8 illustrates only the selected data elements and their immediate parents of the tree hierarchy of FIG. 4 in accordance with an embodiment of the invention.

FIG. 9 illustrates the table schema view of a data element configured in accordance with an embodiment of the invention.

Like reference numerals refer to corresponding parts throughout the several views of the drawings.

### DETAILED DESCRIPTION OF THE INVENTION

The following terminology is used while disclosing embodiments of the invention:

A cascading drop down list is a series of dependent drop down lists. The content of the first drop down list in the series is determined independently. The content of each succeeding drop down list in the series is dependent on the selection made in the drop down list immediately preceding it.

A data element is an object in a data source (e.g., a concept in an XML file, an entity in a relational database). A data element comprises a set of one or more data properties.

A data property is a characteristic or measure associated with a data element (e.g., an attribute in an XML file or a relational database).

An entity-relationship diagram is a visualization that illustrates correlations between objects. In particular, an entity-relationship diagram illustrates which objects comprise other objects. An entity-relationship diagram can be used to illustrate relationships between data structures and data elements, and between data elements and data properties, and the like.

A tree is a visualization that illustrates a hierarchical relationship amongst a set of objects

A virtual data source or target data source is a system that facilitates direct access to data from one or more discrete data sources. A virtual data source comprises one or more data elements. A virtual data source can be consulted in a similar way to a conventional data source of the same type.

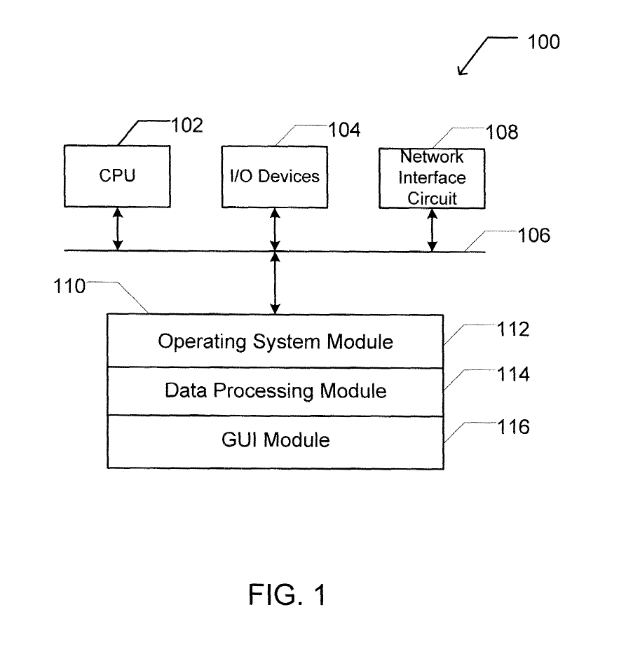

FIG. 1 illustrates a computer 100 configured in accordance with an embodiment of the invention. The computer 100 includes standard components including a central processing unit 102 and input/output devices 104, which are linked by a bus 106. The input/output devices 104 may include a keyboard, mouse, touch screen, monitor, printer, and the like. A network interface circuit 108 is also connected to the bus 106. The network interface circuit SIC) 108 provides connectivity to a network (not shown), thereby allowing the computer 100 to operate in a networked environment.

A memory 110 is also connected to the bus 106. In an embodiment, the memory 110 stores one or more of the following modules: an operating system module 112, a data processing module 114 and a graphical user interface (GUI) module 116.

The operating system module 112 may include instructions for handling various system services, such as file services or for performing hardware dependant tasks. The data processing module 114 includes executable instructions to receive a data source, to analyze the data source and extract data elements and data properties from it, to define or accept specifications for a target data source and to create the target data source. The GUI module 116 may rely upon standard techniques to produce graphical components of a user interface, e.g., windows, icons, buttons and menus.

The executable modules stored in memory 110 are exemplary. It should be appreciated that the functions of the modules may be combined. In addition, the functions of the modules need not be performed on a single machine. Instead, the functions may be distributed across a network, if desired. Indeed, the invention is commonly implemented in a client-server environment with various components being implemented at the client-side and/or the server-side. It is the functions of the invention that are significant, not where they are performed or the specific manner in which they are performed.

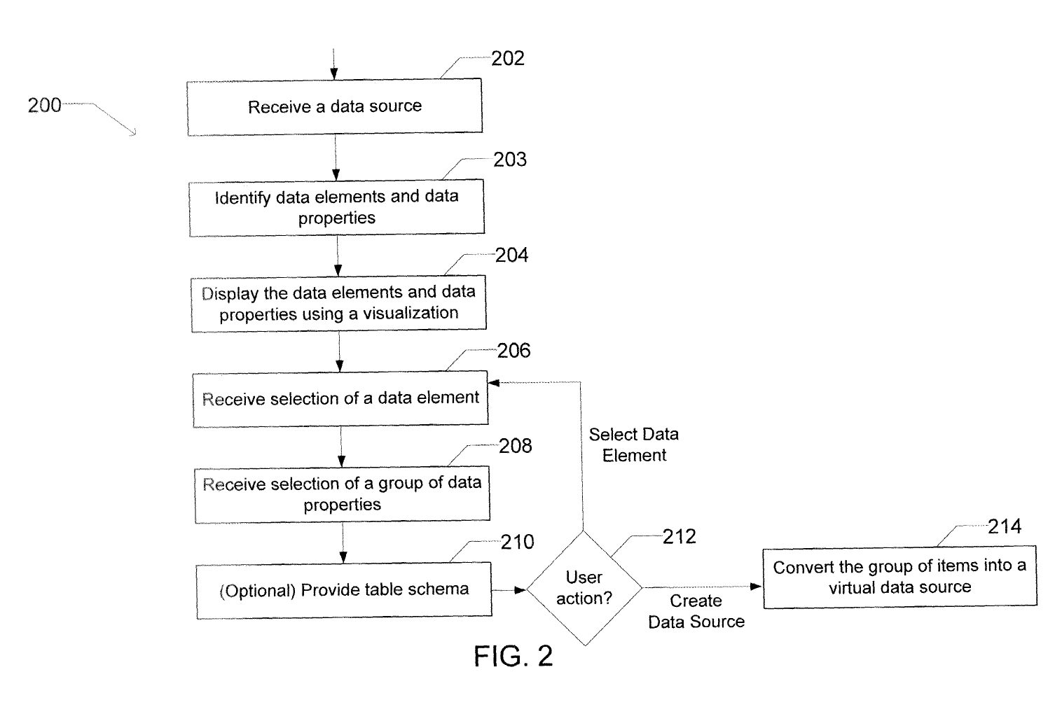

FIG. 2 illustrates a high level workflow that may be implemented by the computer 100 while executing instructions from the data processing module 114. The processing operations 200 illustrate the process of specifying aspects for a target data source.

In the first processing operation 202, the data processing module 114 receives a predetermined, user specified or default data source. The data source is then analyzed and parsed into the identified data elements and data properties 203. In an embodiment, the data source is an XML file the data elements are XML concepts and the data properties are XML attributes. In other embodiments, the data source is a relational database, an On-line Analytical Processing (OLAP) cube, a text file, a data warehouse and the like. The data elements and data properties are then displayed using a visualization (e.g., a tree hierarchy, list, entity-relationship diagram) 204. The data processing module 714 receives a data element 206 selected by the user or specified by a default value, then receives a group of selected data properties 208 that are associated with the data element. In an embodiment, the target data source is a virtual database. In this case, the user optionally provides a table schema, or a default table schema is provided, for the data element 210; the selected data properties equate to the table columns. In other embodiments, the target data source is a virtual data warehouse, a virtual XML file, a virtual OLAP cube and the like. In the next processing operation, the data processing module 114 waits for an action from the user 212. If the user selects another data element (212—Select Data Element), the data processing module 114 returns to the processing operation 206 to receive the selected data element. If the user chooses to create the target data source (212—Create Data Source), the data processing module 114 constructs a target data source 214 based on the supplied data elements and data properties.

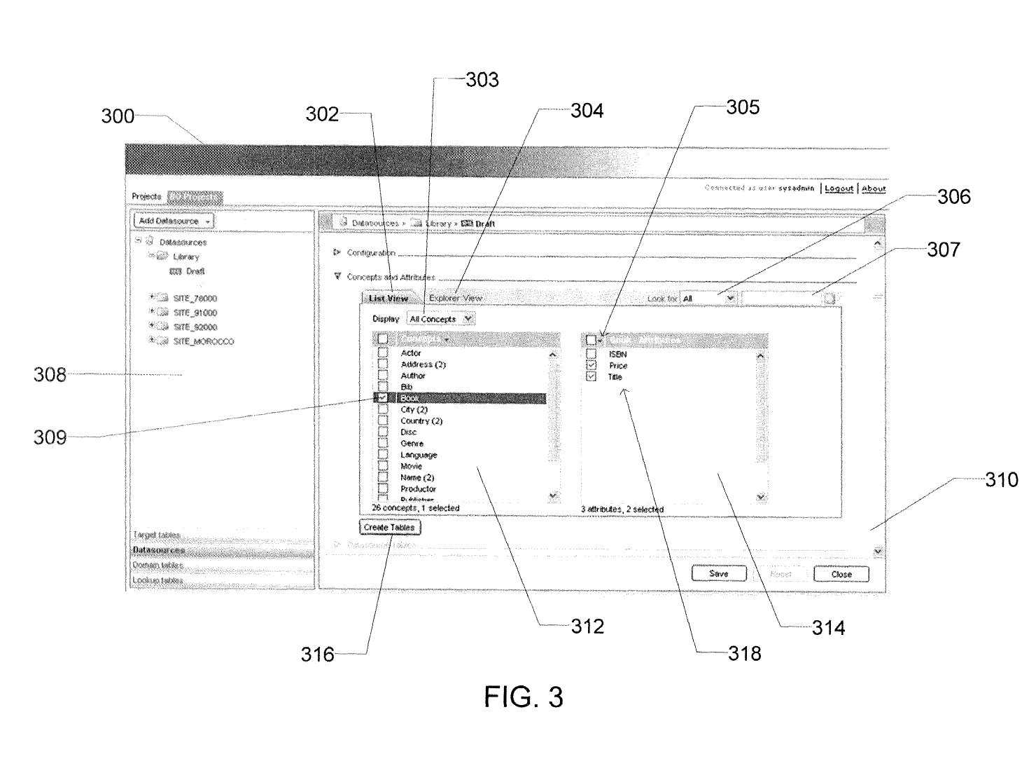

FIG. 3 illustrates the GUI 300 rendered by the GUI module 116 in an embodiment of the invention. The sidebar 308 allows the user to add new target data sources and view existing ones, as well as switch between sections of the application. The area 310 displays information and data associated with the application section and/or target data source selected in the sidebar 308. In an embodiment, the plurality of data elements and the plurality of data properties are displayed using list and/or tree visualizations. Other embodiments use entity-relationship diagrams, cascading drop down lists and the like to provide visualizations of the data elements and data properties. In an embodiment, the user alternates between multiple visualization types using tabbed panes (e.g., the “List View” tab 302 and the “Explorer View” tab 304).

The list view tab 302 displays both the data elements 312 and the data properties 314 as lists. In an embodiment, when the user highlights a data element (e.g., Book 309) the data property list 314 is populated with the applicable data properties for the highlighted data element (e.g. ISBN, Price and Title 318). In an embodiment, all the data properties for a selected data element are selected by default. In an embodiment, a sorting order selection button (e.,g the arrow 307) is used to select a sorting order (e.g., alphabetical order, selection order, data type order) by which to sort the properties. In an embodiment the user can search the data elements and data properties for a word or phrase entered in the search box 307. The user can indicate whether to search both the data elements and data properties just the data elements or just the data properties using the “Look for” drop down list 306. In an embodiment, the search function finds the first instance of the word or phrase. and the user is able to step through subsequent instances using a “Find Next” link or button. In an embodiment, the search is performed on names of the data elements and data properties. In an embodiment, the search is performed on the data stored in the data source. In an embodiment, the “Display” drop down list 303 is used to alternate between viewing all the data elements and viewing search results. Once the user has specified the aspects of the target data source, it can be created by clicking the “Create Tables” button 316.

In an embodiment, validation checks are performed before creating the target data source. The validation checks include, but are not limited to: checking for unique keys, checking that linked data elements contain valid data, checking that the data of a data property complies with the specified data type and length, checking that the data contains a specified number of distinct values and checking that a data element contains at least one data property.

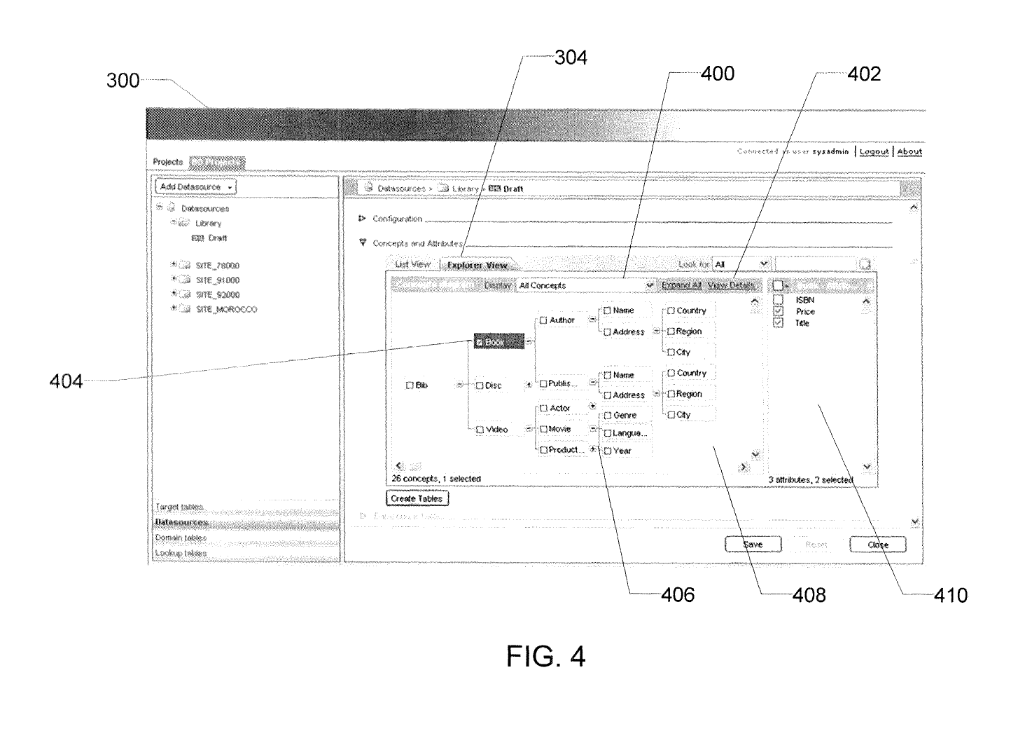

FIG. 4 illustrates the GUI 300 displaying the “Explorer View”. In an embodiment, clicking the “Explorer View” tab 304 displays a tree view of the data elements 408. When a data element is highlighted (e.g., Book 404) the associated data properties are displayed in a list view 410. In an embodiment, the tree 408 may be expanded to view a hidden branch using the expansion link 406. When the branch is displayed, the expansion link is converted to a collapse link. The collapse link allows the user to hide the branch. In an embodiment, the “Display” drop down list 400 is used to display a subset of the tree based on the selected filter. In an embodiment, the filter options are all data elements, only the selected data elements, the selected data elements and their immediate child data elements, the selected data elements and their immediate parent data elements, or a single data element and its immediate parent and child data elements. In an embodiment, highlighting a data element (e.g., Book 404) and clicking “View Details” 402 displays a detail view showing the highlighted data element and its related data elements.

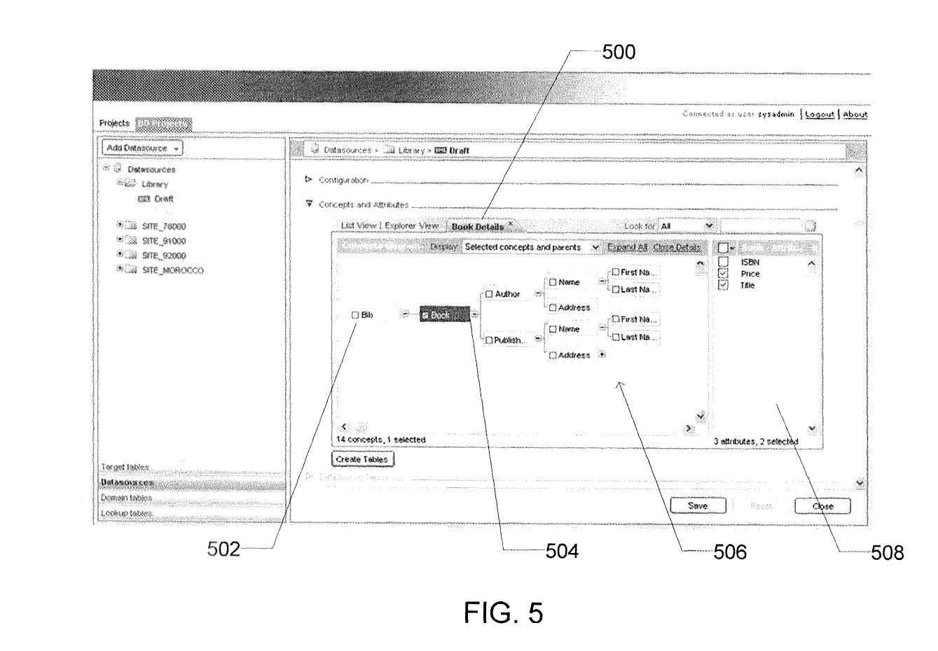

FIG. 5 illustrates the previously mentioned detail view. In an embodiment, a new tab (e.g., the “Book Details” tab 500) is created for each detail view opened, In an embodiment, the default initial detail view displays the detailed data element with highlighting (e.g., Book 504) and its associated data properties 508, as well as its parent branch 502 and all its child branches 506. The detail view tree is also expandable and collapsible just as the “Explorer View” tree is.

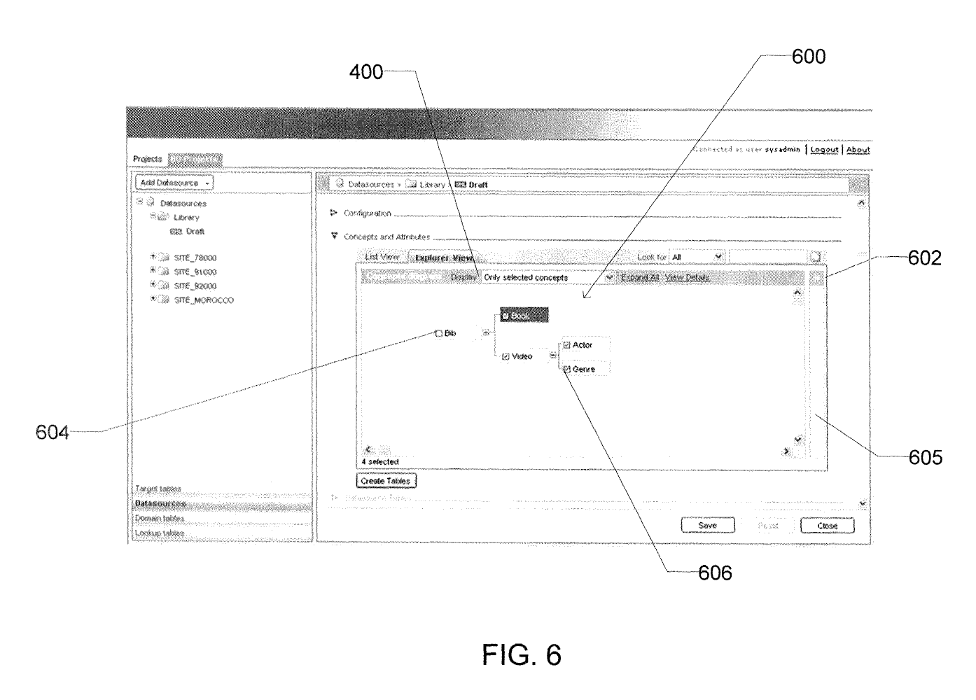

FIG. 6 illustrates the “Explorer View” filtering on only the selected data elements. In an embodiment, the user can activate this filtered view using the “Display” drop down list 400 to specify that only the selected data elements should be displayed. This option displays all the selected data elements 600 and the head node 604 of the entire tree whether it is selected or not. In all views a visual indicator is applied to each selected data element and data property to show that it has been selected. In an embodiment, the indicator is a checked checkbox 606. In other embodiments, the indicator is in the form of an icon, font formatting, highlighting and the like. In an embodiment, the “Explorer View” allows the user to expand and collapse the data properties list using an arrow button 602. In an embodiment, the collapsed data properties list appears as a bar 605 which can be expanded back to a full view of the list.

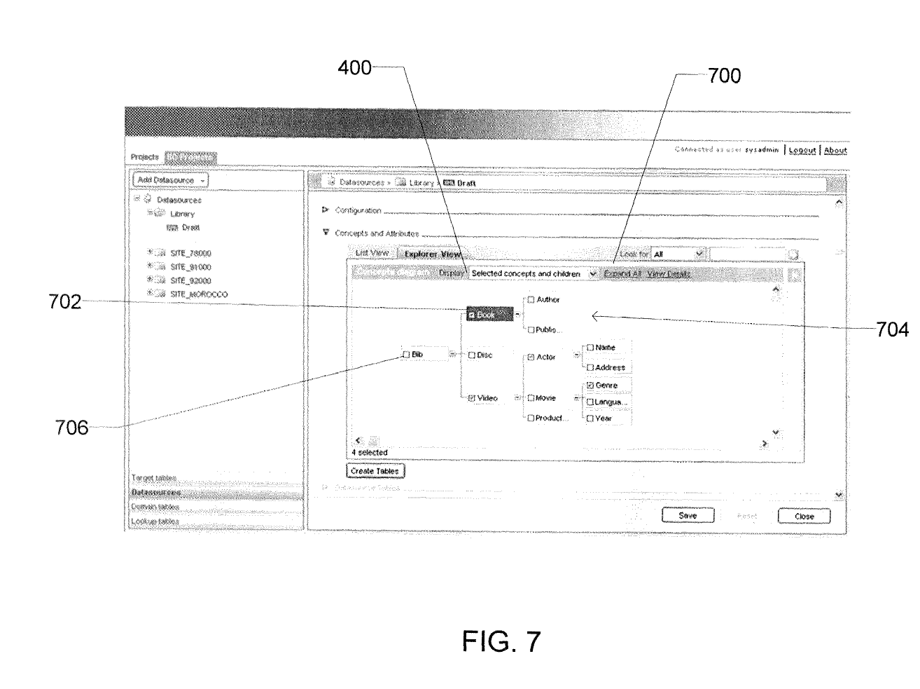

FIG. 7 illustrates the “Explorer View” filtering on the selected data elements and their immediate children. In an embodiment, the user can activate this filtered view with the “Display” drop down list 400, specifying that only the selected data elements (e.g., Book 702) and their immediate children (e.g., the children 704) should be displayed. As when only the selected data elements are shown, the head node 706 of the entire tree is displayed whether it is selected or not. In an embodiment, the “Explorer View” provides an option to expand all branches of the tree at once (e.g., clicking the “Expand All” link 700). This reveals all hidden branches of the given tree, whether it is the full data element tree or a filtered version.

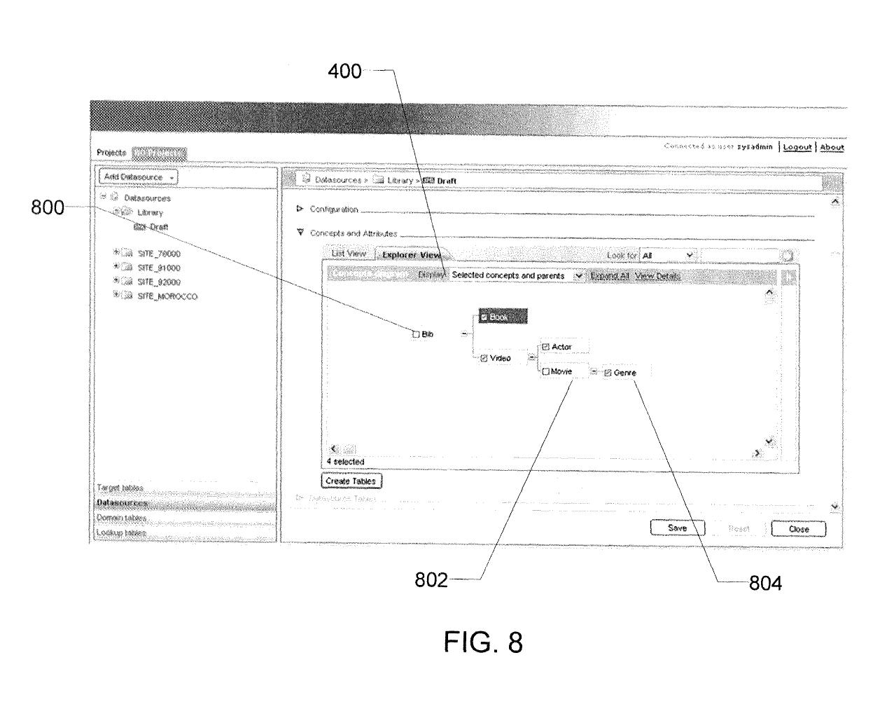

FIG. 8 illustrates the “Explorer View” filtering on the selected data elements and their immediate parents. In an embodiment, the user can activate this filtered view using the “Display” drop down list 400 to specify that only the selected data elements (e.g., Genre 804) and their immediate parents (e.g., Movie 802) should be displayed. The head node 800 of the entire data element tree is displayed whether it has been selected or is the immediate parent of a selected data element.

In an embodiment, the user can specify that the selected data elements and their immediate parents and children be displayed. The head node 800 of the entire data element tree is displayed whether it has been selected or is the immediate parent of a selected data element.

In an embodiment, the “Explorer View” automatically truncates the tree when there are too many data elements to display in the provided area. In an embodiment, truncation is indicated by a linked data element. When the linked data element is clicked, the “Explorer View” is updated to display the linked data element and one or more child branches. If the new tree is truncated, the user can view a truncated portion of the new tree in the same way. In an embodiment, there are options to return to the previously displayed tree or to the original tree.

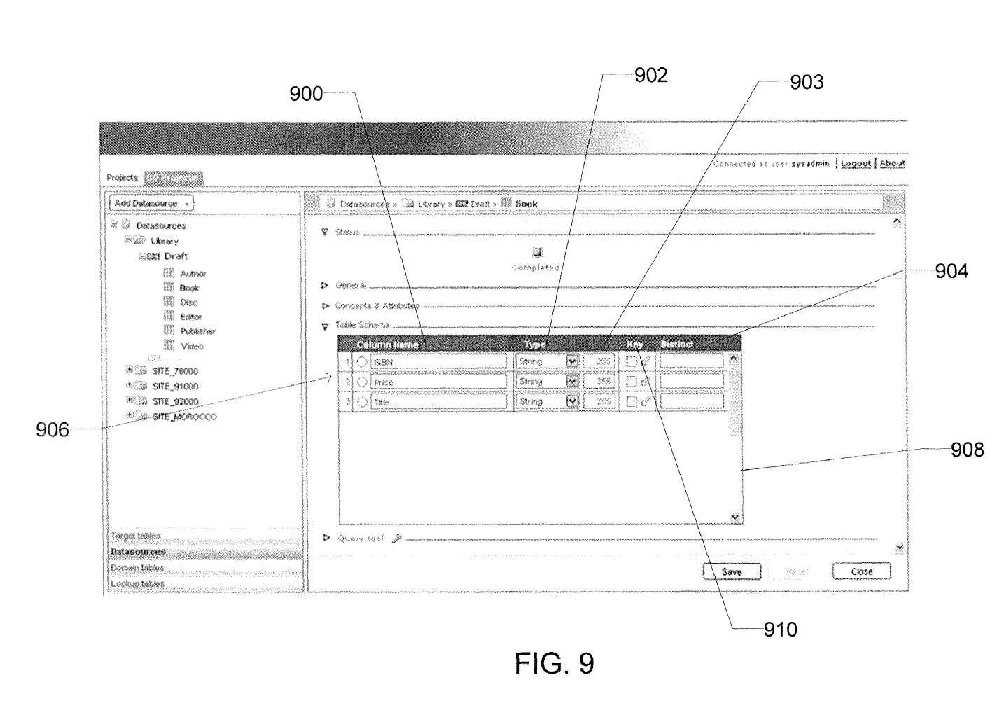

FIG. 9 illustrates a table schema specification interface 908 used in an embodiment of the invention. In an embodiment, the target data source is a virtual database accepting user specified and default table schema definitions. The table schema interface 908 displays the previously selected or default data properties for the data element. In an embodiment, there are six components to the table schema interface: column order 906, column name 900, data type 902, data type length 903, key 910 and the number of distinct values 904. In an embodiment, the column order 906 is changed using the radio buttons. When a radio button is selected, a “Change Position” option appears, allowing the user to specify the column's position in the order. The column name 900 specifies a descriptive name for the given data property. The data type 902 indicates the database supported data type of the data property (e.g., String, Boolean, Integer) and data type length 903 specifies the number or characters, or bits depending on the data type, allotted for the data property. The key 910 indicates whether the data property is part of the primary key for the table. The number of distinct values 904 is an optional field to specify how many distinct values are available for the data property used for query optimization. Default settings are set for each data property: the column name is set to the data property name, the data type is set to String with a length of 255, the key indicator is set to false and no distinct value is specified.

In an embodiment, when a user views an existing target data source they are notified if the data source has been altered. Furthermore, they will receive detailed notification regarding which data elements have been removed from the data source and which data elements have been added to the data source.

In an embodiment, the user can edit any aspects of an existing target data source (e.g., selected data elements, selected data properties, table schemas). In an embodiment, when editing a target data source, the user can opt to view only the concepts already existing in the target data source. In an embodiment, when editing an existing target data source, changes to data element selection and data property selection are tracked by a visual indicator such as highlighting, font formatting or the like.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium, comprising executable instructions to:
translate a data source into a plurality of data elements, wherein a data element in the plurality of data elements comprises a plurality of data properties;
display the plurality of data elements using a visualization;
receive a group of data elements selected from the plurality of data elements;
receive a group of data properties selected from the plurality of data properties associated with each data element in the group of data elements;
provide a table schema for data elements in the group of data elements; and
convert the group of data elements into a target data source.

2. The computer readable storage medium of claim 1 wherein the data source is a physical data source.

3. The computer readable storage medium of claim 1 wherein the data source is an XML file.

4. The computer readable storage medium of claim 1 wherein the target data source is a virtual relational database.

5. The computer readable storage medium of claim 4 wherein a data element maps to a table in the virtual relational database and a data property maps to a column in the table.

6. The computer readable storage medium of claim 1 wherein the visualization is selected from a tree, a list, a cascading drop down list and an entity-relationship diagram.

7. The computer readable storage medium of claim 1 wherein:
the visualization is collapsible; and
the visualization is expandable.

8. The computer readable storage medium of claim 1 wherein the table schema is specified by a user.

9. The computer readable storage medium of claim 1 further comprising executable instructions to:
provide a notification when the data source is updated; and
indicate data elements in the group of data elements that have been deleted from the data source.

10. The computer readable storage medium of claim 9 further comprising executable instructions to indicate data elements that have been added to the data source.

11. The computer readable storage medium of claim 1 further comprising executable instructions to validate a data object selected from a key, a link, a dataset, a data format, a table schema, a data source structure and a target data source structure.

12. The computer readable storage medium of claim 1 further comprising executable instructions to perform a search for a user specified phrase of one or more words in a category selected from data elements and data properties.

13. A computer readable storage medium, comprising executable instructions to:
locate a data source comprising a plurality of data elements;
present the data source using a visualization;
accept selection of a group of data elements from the plurality of data elements, wherein a data element in the plurality of data elements comprises a plurality of data properties;
receive selection of a subset of data properties from the plurality of data properties for each data element in the group of data elements via the visualization;
specify a table schema for data elements in the group of data elements; and
convert the group of data elements into a target data source.

14. The computer readable storage medium of claim 13 wherein the data source is a physical data source.

15. The computer readable storage medium of claim 13 wherein the data source is an XML file.

16. The computer readable storage medium of claim 13 wherein the target data source is a virtual relational database.

17. The computer readable storage medium of claim 13 wherein the visualization is selected from a tree, a list, a cascading drop down list and an entity-relationship diagram.

18. The computer readable storage medium of claim 17 further comprising executable instructions to select a subset of the tree to be displayed based on filter criterion.

19. The computer readable storage medium of claim 18 wherein the filter criterion is selected from the plurality of data elements, the group of data elements, the group of data elements and a set of child data elements, the group of data elements and a set of parent data elements, and a data element and a set of parent and child data elements.

20. The computer readable storage medium of claim 17 further comprising executable instructions to sort a list.

21. The computer readable storage medium of claim 13 wherein the table schema is provided by a user.

22. The computer readable storage medium of claim 13 further comprising executable instructions to edit a target data source schema by performing a specified action selected from adding a data element from the plurality of data elements to the group of data elements, removing a data element from the group of data elements, removing a data property from a data element in the group of data elements, adding a data property to a data element in the group of data elements and updating a table schema of a data element in the group of data elements.

23. A computer readable storage medium comprising executable instructions to receive an XML file;
display the XML file using a visualization, wherein the XML file expresses a plurality of concepts;
receive a group of concepts selected from the plurality of concepts, wherein a concept in the plurality of concepts comprises a plurality of attributes;
receive a group of attributes selected from the plurality of attributes for each data element in the group of data elements;
specify a table schema for each concept in the group of concepts; and
convert the group of concepts into a virtual relational database.

24. The computer readable storage medium of claim 23 wherein a table in the virtual relational database corresponds to a concept in the XML file and a column in the table corresponds to an attribute of the concept.

25. The computer readable storage medium of claim 23 wherein the visualization is selected from a tree, a list, a cascading drop down list and an entity-relationship diagram.
